(19) United States
(12) Patent Application Publication
(10) Pub. No.: US 2008/0289440 A1
(43) Pub. Date: Nov. 27, 2008

(54) Linear/Rotary Drive Assembly

(75) Inventors: Joachim Denk, Nurnberg (DE); Detlef Potoradi, Bad Neustadt/Saale (Muhlbach) (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/095,820

(22) PCT Filed: Nov. 29, 2006
(86) PCT No.: PCT/EP2006/069055

§ 371 Date: Jun. 2, 2008

(30) Foreign Application Priority Data
Dec. 1, 2005 (DE) 10 2005 057 370.3

(51) Int. Cl. F16H 29/02

(52) U.S. Cl. 74/89.34

(57) ABSTRACT

The invention relates to a linear/rotary drive assembly (1) comprising means for performing a rotary movement, a linear movement and ensuring a magnetic bearing of a common drive train (2) when the linear/rotary drive assembly (1) is operated.

The invention relates to a linear/rotary drive assembly.

Particularly in machine tool applications, a spindle used in this case has to execute a movement in the longitudinal direction in addition to a rotational movement. The solutions known hitherto for extending the degree of freedom of rotation of a tool spindle of this type by this degree of freedom of lift involve moving the entire spindle axially by means of a separate drive based, for example, on ball-rolling spindles. This leads to a comparatively bulky set-up and to a comparatively high weight of the overall drive assembly.

Drive assemblies are known which generate a rotational and axial movement with comparatively small axial travels. This takes place particularly in the case of combined lifting and rotary spindles. In this drive assembly, the spindle functions at the same time as a rotor of a rotary drive and as an axially moved part of a linear drive. However, since in this case the spindle has to be movable both in rotation and linearly, a corresponding mounting is highly complicated and correspondingly costly.

The hitherto known bearing concepts based on conventional ball bearings and linear guides are complicated to implement in mechanical terms.

The hydrostatic bearings employed hitherto also cause comparatively high frictional losses and the sealing problem is solved only inadequately.

Magnetically mounted bodies are known, for example, from DE 28 33 893.

Proceeding from this, the object on which the invention is based is to provide for a linear/rotary drive assembly a mounting which is comparatively simple to implement and which has sufficient rigidity and insensitivity to pendulum moments even at relatively high rotational speeds, such as occur particularly in machine tools.

The set object is achieved by means of a linear/rotary drive assembly with means for carrying out a rotational movement, a linear movement and a magnetic mounting of a common drive train during the operation of the linear/rotary drive assembly.

Since in this case both a rotary drive assembly and a translational drive assembly are present on the drive train, these drives can perform the function of both an axial mounting and a radial mounting.

In a further embodiment, the drive train is mounted solely by means of two axial bearings, advantageously at the start and end of the drive train, an axial mounting taking place by means of the linear drive. The advantages of such a mounting of linear/rotary drives are that in this case an approximate freedom from friction is afforded and therefore a comparatively higher efficiency of the linear/rotary drive assembly is obtained.

Furthermore, owing to the magnetic mounting of this drive train, freedom from maintenance and freedom from wear are ensured, and fault-free operation of the overall linear/rotary drive assembly is guaranteed.

Moreover, owing to the freedom from lubricants, if the conventional collecting bearings used, if appropriate, are dispensed with, there are no sealing problems. On account of the freedom from lubricants of the magnetic bearing arrangements during the normal operation of the linear/rotary drive assembly, the latter is particularly suitable for use in vacuum applications.

Furthermore, the magnetic mounting makes it possible to have high rotational speeds in the range above 40 000 revolutions per minute, which are therefore extremely advantageous particularly for machine tool construction. A further advantage is the high rigidity of this bearing arrangement in conjunction with a linear/rotary drive. The mounting of the drive train in this case takes place in the axial and the radial direction. This mounting may take place rotationally and linearly. The mounting according to the invention is, furthermore, an integral part of the drives which surround the drive train or are designed as part of the drive train.

In this case, a suitable control, the sensors of which are part of a motor or of a separate magnetic bearing, can detect the actual-value position of the drive train and thereupon emit, via suitable amplifiers or control arrangements, a power variable which, via a magnet coil of these bearing arrangements or of the drive, sets the desired value which, if appropriate, is desired.

Suitable sensors in this context are angle current sensors.

Since, in the event of the failure of one or other magnetic bearing, a safeguarded emergency operation is to be maintained for a predeterminable time, collecting bearings are advantageously provided, which are implemented as conventional rolling or plain bearings or as passive magnetic bearings, that is to say by means of permanent magnets. The collecting bearings, which are designed as conventional bearing arrangements, are in this case located outside the drive. The passive magnetic bearings are located outside or inside the drive, that is to say then form part of the drive.

The drive train itself is constructed in one piece or from a plurality of modules assembled in series. In this case, in a further embodiment, the drive train or at least a module of the drive train is designed as a hollow shaft which then, if appropriate, contains means for cooling, position detection, etc.

Further means are in this case provided on or in the drive train, which interact with the respective drive devices, that is to say the stators of the rotary motors or linear motors, electromagnetically. These are advantageously correspondingly configured elements of the drive train, for example rack profiles.

In a further advantageous embodiment, permanent magnets are arranged on the drive train or in axially running pockets of the drive train and with their magnetic field interact electromagnetically with an alternating field generated by a stator and thus, in addition to the bearing function, generate a rotational or linear movement.

Special arrangements of the permanent magnets on the drive train, that is to say with obliquely running magnetic portions which are arranged, for example, in a V-shaped manner, can reduce the axial forces and the pendulum torques, so that the magnetic bearings have to satisfy correspondingly reduced requirements.

The invention and further advantageous embodiments of the invention according to the subclaims are explained in more detail in the following diagrammatically illustrated exemplary embodiments. In the drawing:

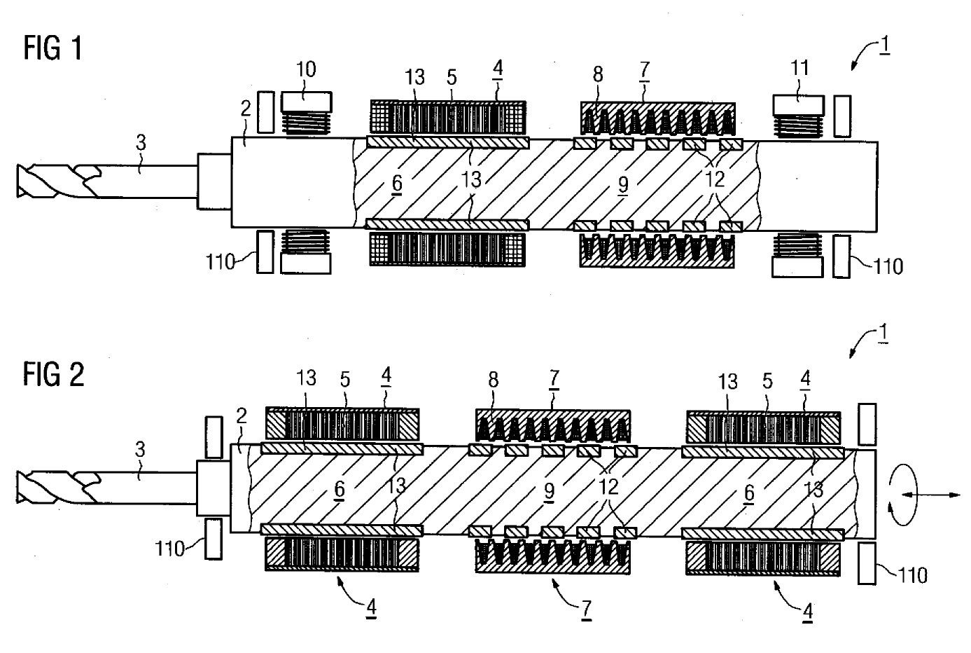

FIG. 1 shows a basic arrangement of a drive train of a linear/rotary drive,

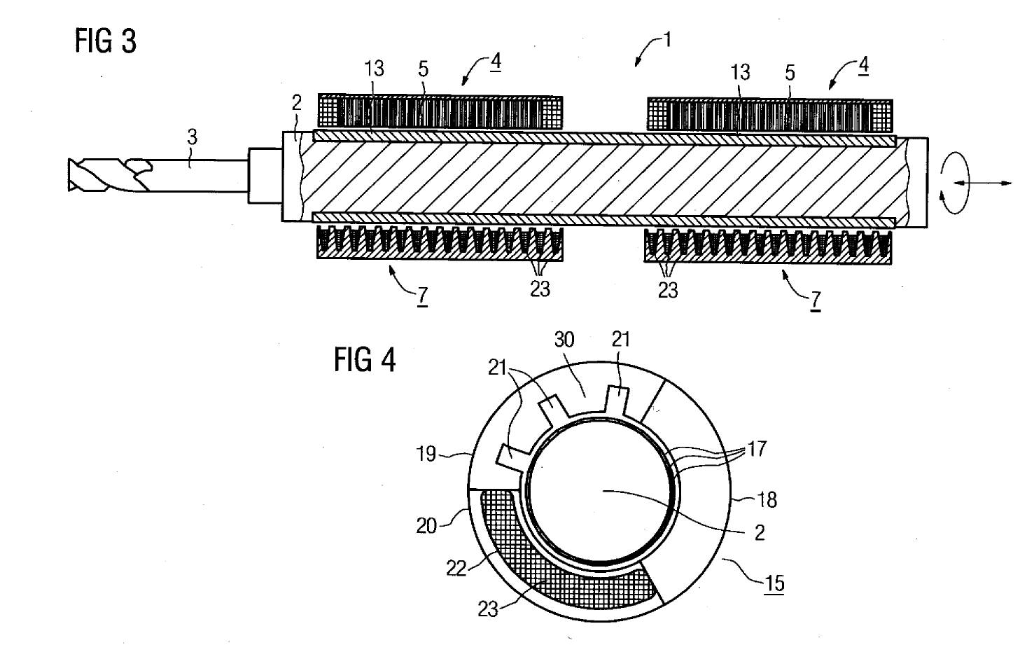

FIGS. 2 and 3 show further exemplary embodiments,

FIG. 4 shows a cross section of a drive according to FIG. 3,

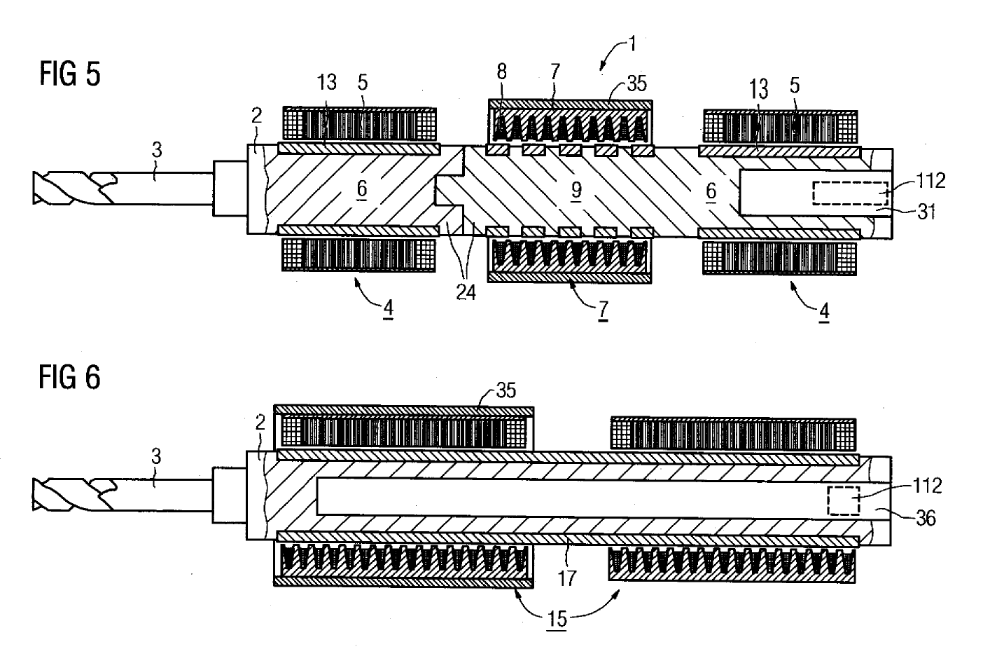

FIGS. 5, 6 show further exemplary embodiments,

FIGS. 7 to 9 show various versions of the drive train.

FIG. 1 shows a linear/rotary drive assembly 1 with a drive train 2 which has, for example, a drill 3 as a tool in its axial extension. The drill 3 can be moved in rotation by means of the rotary drive 4 and in the axial direction by means of the linear drive 7. Furthermore, the drive train 2 is mounted radially by means of magnetic bearings 10 and 11 illustrated basically in this exemplary embodiment. The linear drive 7 performs a function of axial mounting and/or positioning. The rotary drive 4 is constructed basically by means of a stator 5 and a rotor 6 which forms part of the drive train 2. The rotor 6 has, for example, permanent magnets 13 which are arranged so as to be distributed in the circumferential direction, and in this case the permanent magnets 13 may be arranged as surface magnets or as buried permanent magnets 13.

The linear drive 7 likewise has a stator 8 and a portion of the drive train 2 as a rotor 9, the drive train 2 likewise having permanent magnets 12 in this region. By means of a special arrangement of the permanent magnets 12, 13, torque undulations, pendulum moments and axial forces can be reduced, so that the magnetic bearings 10, 11 perform merely a radial reception function.

The drive train 2 is constructed in portions such that the respective portions, for example the rotor 6 and rotor 9, interact electromagnetically in each case with their electromagnetically corresponding stationary portions, for example the stator 5 and stator 8. If present, this also applies to the explicitly designed magnetic bearings 10, 11.

FIG. 2 shows a further embodiment of a linear motor 7 which is preferably arranged between two rotary drives 4. The magnetic bearings 10 and 11 according to FIG. 1 are therefore no longer necessary, since the rotational movement is generated and the radial bearing function assumed by the rotary drives 4. The linear drive 7 generates a translational movement and assumes the axial bearing function.

In a further embodiment according to FIG. 3, only two drives 15 are present in each case with respect to the drive train 2, so that there is likewise no need to provide separate magnetic bearings 10, 11. The magnetic bearing function is in this case assumed by the drives 15 themselves which in each case are provided both as a rotary drive and radial bearing and a translational drive and axial bearing. In this case, each drive 15 in itself forms a combination of a rotary and of a translational drive. The respective portion of the drive train 2 is in this case to be adapted to these special drives 15.

FIG. 4 shows a basic illustration of a drive 15 according to the embodiment illustrated in FIG. 3. The drive train 2 is provided with a bundle of laminations 16 on or in which the permanent magnets 17 are located. The stator 18 of this drive 15 has, as seen in the circumferential direction, at least two different segments 19, 20. The segment 19 is in this case designed as a rotary part motor with axially running slots 21 basically illustrated, a corresponding winding system adapted to this type of motor being arranged in the slots 21. This winding system may be constructed from toothed coils, that is to say in each case from coils comprising a tooth 30 or from conventional chordal coils.

The other segment 20 is designed as a translational part motor in which the slots 22 in each case run in the circumferential direction, thus forming at least one slotted part circle, the windings 23 being arranged in this.

FIG. 5 shows a linear/rotary drive assembly 1 in which the drive train 2 is constructed from two modules 24, the module which faces away from the tool 3 being designed at least in portions as a hollow shaft 31. Consequently, the inertia of the drive train 2 is reduced, and construction space for transmitters, not illustrated in any more detail, and/or electronic control and regulating devices is provided. Advantageously, the modules 24 are assigned to the respective drives 4, 7, 15, since, depending on the type of drive, portions of the drive train 2 which are structured differently with permanent magnets are to be assigned to these drives 4, 7, 15.

FIG. 6 shows an assembly which is based on the version according to FIG. 3 and in which the drive train 2 is designed as a continuous hollow shaft 36.

Transmitters, cooling devices, such as heat pipes, cool jets or thermosyphons, etc., can be accommodated in the hollow shaft 36 or else in a hollow shaft 31 in portions, according to FIG. 5.

FIG. 7 shows a rotor 6 for a rotary drive 4. The respective permanent magnets 13 are in one piece in the axial direction or are composed of a plurality of small magnetic plates arranged in series.

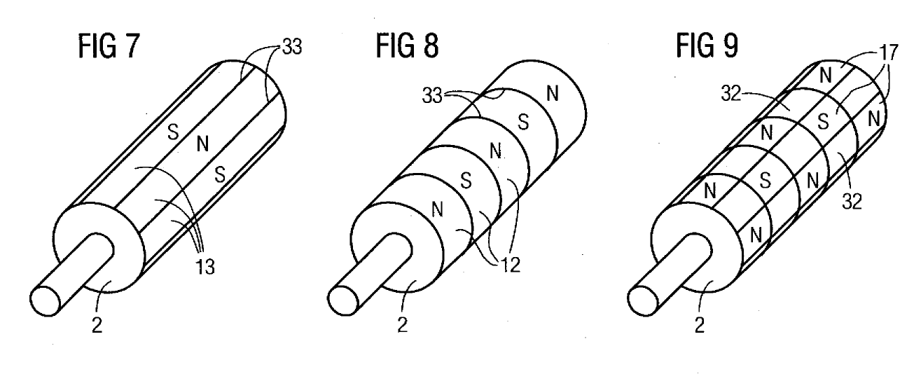

FIG. 8 shows one of many possible implemented portions, see also FIG. 5, of the drive drain 2, which is designed as a rotor 9 and is responsible for the translational movement of the drive train 2. The permanent magnets 12 are correspondingly polarized ring magnets, or they are constructed from a plurality of magnet segments which are positioned, for example glued, on the drive train 2.

The pole covering of the portion, covered with permanent magnets, of the drive train 2 of the rotary and translational drive 4, 7 is 50% to 100%, depending on the latching forces to be eliminated. The webs 33 lying between the permanent magnets lead not only to easier assembly, but also to an additional reluctance moment.

So that the rotary drive 4 generates not only the tangential forces causing the rotation, but also radial forces for mounting the drive train 2, two separate winding systems are to be provided in the stator 5 in the axially running slots.

For example, in addition to the number of poles by which tangential forces are generated, the stator 5 must have a further number of poles which is larger or smaller by 2. By means of this number of poles, the radial forces are then generated inside this drive. (Number of rotor poles: 4; number 1 of stator poles: 4; number 2 of stator poles: 2 or 6).

The two separate winding systems of this drive 4 are in this case controllable separately.

Portions of the drive train 2 according to FIG. 9 are suitable particularly for linear/rotary drives 1 according to FIG. 3 and FIG. 6, in one drive 15 at least one winding system being located in axial slots and at least one winding system 23 being located in circumferentially running slots 21, 22. The permanent magnets 31 are arranged in a checkerboard manner. The interspaces 32 are air-core, that is to say they are covered with an amagnetic material, or they are free of materials.

In a further advantageous embodiment, the drives 4, 7, 15 have a cooling jacket 35 in each case around the stators 5 or stators 7, which cooling jackets discharge the waste heat due to liquid cooling or air cooling from the stator 5 or stator 7. These cooling jackets are illustrated by way of example in FIGS. 5 and 6.

1.-9. (canceled)

10. A linear/rotary drive assembly, comprising a drive train for operating a workpiece, said drive train including a rotary drive for generating a rotational movement of the workpiece, and a linear drive for generating a linear movement of the workpiece, said rotary and linear drives being constructed to provide a magnetic mounting for support of the drive train during operation thereof, wherein the linear drive provides an axial support of the drive train, and the rotary drive provides a radial support of the drive train.

11. The drive assembly of claim 10, wherein the drive train is supported by an axial magnetic mounting and a radial magnetic mounting.

12. The drive assembly of claim 11, wherein the magnetic mounting is realized by at least one said rotary drive and at least one said linear drive.

13. The drive assembly of claim 10, further comprising magnetic bearings for additionally supporting the drive train.

14. The drive assembly of claim 10, wherein the drive train has at least two collecting bearings which, in a safety situation, at least temporarily assume part of the support of the drive train.

15. The drive assembly of claim 14, wherein the collecting bearings are conventional rolling or plane bearings or are designed as passive magnetic bearings.

16. The drive assembly of claim 10, wherein the drive train has at least one axial portion which is designed as a hollow shaft.

17. The drive assembly of claim 16, wherein the at least one axial portion of the drive train accommodates means for rotor position detection, rotational speed detection, and cooling.

18. The drive assembly of claim 10, for use in lifting/rotary spindles of machine tools.
